(19) United States
(12) Patent Application Publication
(10) Pub. No.: US 2019/0065550 A1
(43) Pub. Date: Feb. 28, 2019

(54) QUERY OPTIMIZER FOR COMBINED STRUCTURED AND UNSTRUCTURED DATA RECORDS

(71) Applicant: 3M INNOVATIVE PROPERTIES COMPANY, St. Paul, MN (US)

(72) Inventors: Brian J. Stankiewicz, Austin, TX (US); Nicholas A. Asendorf, St. Paul, MN (US); Jennifer F. Schumacher, Woodbury, MN (US); Kelly S. Peterson, Salt Lake City, UT (US)

(21) Appl. No.: 16/092,483

(22) PCT Filed: Apr. 7, 2017
(86) PCT No.: PCT/US17/26636

§ 371 Date: Oct. 10, 2018

Related U.S. Application Data
(60) Provisional application No. 62/323,220, filed on Apr. 15, 2016.

(51) Int. Cl. G06F 17/30

(52) U.S. Cl. CPC G06F 17/30463; G06F 17/30554; G06F 17/3053; G06F 17/30324

(57) ABSTRACT

A method of optimizing a query over a database, the method includes obtaining a set of data records from the database, the data records containing structured data and unstructured data documents, extracting the structured and unstructured data from the set of data records, transforming the structured and unstructured data into a vector that is an element of a weighted vector space, receiving a target data record containing structured and unstructured data, generating a target vector for the target data record, executing a similarity algorithm using the target vector and the weighted vector space generated by the collection of database records to provide a reduced number of data records that are most similar to the target data record, and executing a query against the reduced number of data records that are most similar to the target data record.

### FIELD

The present inventive subject matter is related to evaluation and optimization of the assignment of protocols and processes within an application environment, and in particular to a system database having combined structured and unstructured data records.

### BACKGROUND

A query is a selective and/or actionable request for information from a database. Structured data refers to data that is arranged in a specific format or manner such as a fixed field within a record or file. This includes data contained in relational databases and spreadsheets. Examples of structured data may include codes, names, gender, age, address, phone number, etc. Structured data can also be data (fields) that take a pre-defined set of values. For example: state of residence can be one of the fifty states. Unstructured data refers to data that is not arranged in a specific format or manner. Examples of unstructured data may include social media posts, multimedia, medical records, notes, video or audio files, journal entries, books, image files, or metadata associated with a document or file.

Query optimization is conventionally performed by considering different query plans that may involve one or more indices or tables that have been previously built covering the database. Query plans may utilize various merge or hash joins of the tables. Processing times of the various plans may vary significantly. The purpose of query optimization is to discover and implement a plan that searches structured and/or unstructured data in a minimum amount of time and provides accurate results. The search space for the plans may become quite large, leading to the query optimization time rivaling, if not exceeding, the time allotted to perform the query.

### SUMMARY

The present invention provides methods, devices, and storage devices for the query optimization and the evaluation of query processes.

A method of optimizing a query over a database, the method includes obtaining a set of data records from the database, the data records containing structured data and unstructured data documents; extracting the structured and unstructured data from the set of data records; transforming the structured and unstructured data into a vector that is an element of a weighted vector space, receiving a target data record containing structured and unstructured data; generating a target vector for the target data record; executing a similarity algorithm using the target vector and the weighted vector space generated by the collection of database records to provide a reduced number of data records that are most similar to the target data record; and executing a query against the reduced number of data records that are most similar to the target data record.

A machine readable storage device having instructions for execution by a processor of the machine to perform operations. The operations include obtaining a set of data records from the database, the data records containing structured data and unstructured data documents; extracting the structured and unstructured data from the set of data records; transforming the structured and unstructured data into a vector that is an element of a weighted vector space; receiving a target data record containing structured and unstructured data, generating a target vector for the target data record, the target vector being an element of the weighted vector space; executing a similarity algorithm using the target vector space of the target data record and the weighted vector space corresponding to the set of data records to provide a reduced number of data records that are most similar to the target data record; and executing a query against the reduced number of data records that are most similar to the target data record.

A device includes a processor and a memory device coupled to the processor and having a program stored thereon for execution by the processor to perform operations. The operations include obtaining a set of data records from the database, the data records containing structured data and unstructured data documents; extracting the structured and unstructured data from the set of data records; transforming the structured and unstructured data into a vector that is an element of a weighted vector space; receiving a target data record containing structured and unstructured data; generating a target vector for the target data record, the target vector being an element of the weighted vector space; executing a similarity algorithm using the target vector space of the target data record and the weighted vector space corresponding to the set of data records to provide a reduced number of data records that are most similar to the target data record; and executing a query against the reduced number of data records that are most similar to the target data record.

### BRIEF DESCRIPTION OF THE DRAWINGS

FIG. 1 is a block diagram of a system for optimizing queries of structured data utilizing unstructured data according to an example embodiment.

FIG. 2 is a block diagram illustrating modules or programs that may be executed from a memory to perform methods associated with optimizing queries according to an example embodiment.

FIG. 3 is a flowchart illustrating a method of optimizing a structured data query utilizing natural language processing of unstructured data to reduce a set of records for execution of the query according to an example embodiment.

FIG. 4 is a representation of a sample similarity matrix illustrating the reduced set of records according to an example embodiment.

FIG. 5 is an example screen shot of a query entry screen for generation of a query by a user according to an example embodiment.

FIG. 6 is a block schematic diagram of a computer system to implement methods according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware, or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a”, “an”, and “the” are not intended to refer to only a singular entity, but include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

In various embodiments, a set of records may be reduced based on unstructured data so that a query of structured data may be executed over the reduced set of records. Healthcare is an example application environment that provides a continually evolving set of records. Other example applications include: construction, transportation and logistics, manufacturing, sales or finance, human resource, education and/or legal, etc. Examples of healthcare related structured data may include encounter information such as diagnostic codes, diagnostic related group (DRG) codes, international classification of diseases (ICD) codes, and patient demographics (name, age, gender, height, weight, address, phone number, etc.), facility, and doctor information. The unstructured data may for example, be the notes of a healthcare professional, such as a doctor or other healthcare provider, made during an encounter with a patient. Other unstructured data may include laboratory data, such as EKG readings, MRI results, or other measurements, such as imaging results. Data may be obtained instantaneously (i.e., real-time) or be collected over aggregated time intervals (e.g., hours, days, weeks, etc.)

Queries of the structured data in the reduced set of records may be used to perform benchmarking, which basically means comparing parameters in the reduced set of records in order to gauge performance. These comparisons can be used by grouping patients, care-givers, and/or facilities. Benchmarking in the medical profession can be used to identify areas for improvement in patient outcomes and reduction of costs. The benchmarking queries might include examples such as “What is the average length of stay?”, “What is the average cost of care”, etc. These types of queries may be run against a reduced set of records. In some examples, a user may select one or more sets of notes, also referred to as documents, and use them to find similar documents in the set of records. Those records containing the similar documents are selected for the reduced set of records. When the queries are run against the reduced set of records containing documents that are most similar to the target document(s), the comparison of such metrics may become more accurate, as the records in the reduced set are less likely to include records that are not relevant to the metrics being compared. Further, by reducing the number of records, queries may be run more quickly, conserving computing resources.

Grouping patients together by similar medical history and encounter can provide feedback to care-givers for treatment protocols. Treatment protocols are generally defined as the description of steps taken to provide care and treatment to one or more patients or to provide safe facilities and equipment for the care and treatment of patients. Protocols may include, for example, a list of recommended steps, who performs aspects of the steps, and where the steps should be performed. Assessment of a selected treatment protocol against the grouped patients provides insight as to what treatments were and were not effective in impacting patient care.

Medical code (e.g., ICD, SNOMED, etc.), procedure or diagnosis, identification may also be facilitated by performing queries on a reduced set of records based on documents. Similar documents may have similar codes, and grouping coding completed documents with new documents may suggest codes for the new documents based on the coding of completed documents.

Many other application environments may also benefit from reducing a set of records prior to performing benchmarking activities. Examples include, but are not limited, to the following. Many other applications may also benefit.

Orthodontia documents may be used to group patients with similar orthodontia scans (unstructured data), which may be filtered by patient demographics.

Human resource records may be grouped by employees to facilitate performance of benchmarks on groups of employees related to hours worked, individual support services (ISS) submitted, healthcare cost, etc.

Manufacturing records may be grouped by products or processes and used to identify processes causing high failure rates. Unstructured data used for such grouping may include image data for example.

Sales or finance records may be grouped by unstructured data as filtered by products, customers, or other information and may be used to recommend systems for sales representatives. Unstructured data may include notes of a sales representative following a customer interaction.

Education records may group students by grades, zip code, income level and answers to essay questions, which is unstructured data.

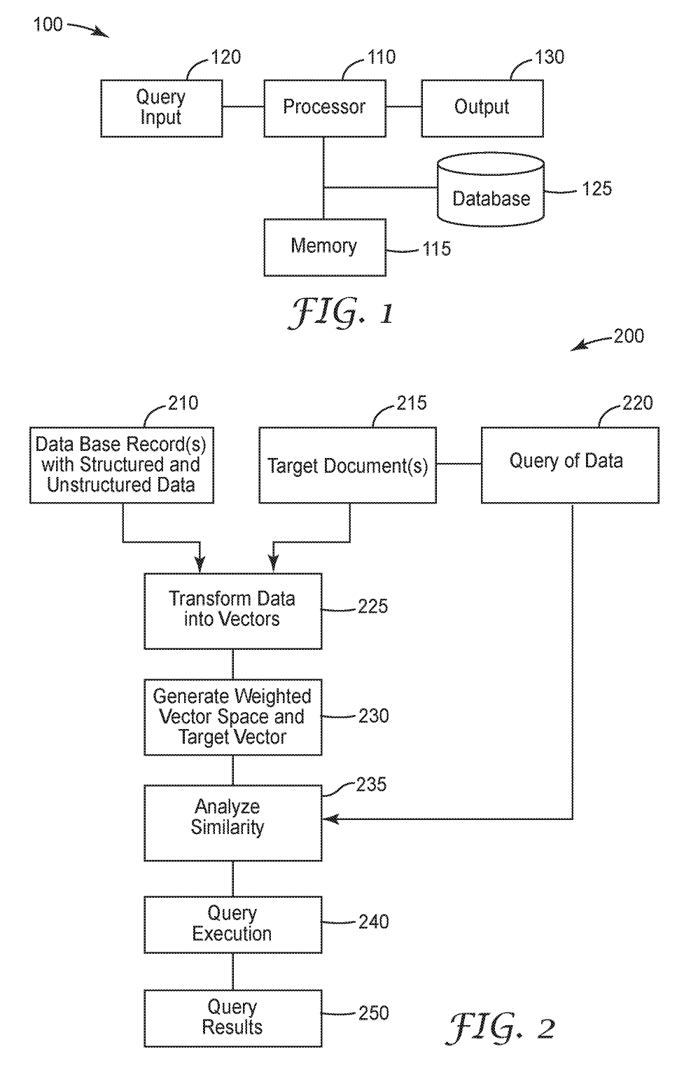

FIG. 1 is a block diagram of a system 100 for optimizing queries of structured data utilizing unstructured data. System 100 includes a processor 110 with a memory 115 that stores programming for causing the processor 110 to implement one or more query optimization methods. A query input 120 is coupled to the processor and provides the ability for a user to generate and provide queries. The queries may be related to performing benchmarking activities over records stored in a database 125, and may include calculations, such as aggregations of results and statistical analyses. Database 125 may include a query engine that executes queries over selected records and provides results to processor 110 for output 130 to a printer, storage device, or other device such as a display.

Processor 100 may include one or more general-purpose microprocessors, specially designed processors, application specific integrated circuits (ASIC), field programmable gate arrays (FPGA), a collection of discrete logic, and/or any type of processing device capable of executing the techniques described herein. In some examples, processor 110 or any other processors herein may be described as a computing device. In one example, memory 115 may be configured to store program instructions (e.g., software instructions) that are executed by processor 110 to carry out the processes described herein. Processor 110 may also be configured to execute instructions stored by database 125. In other examples, the techniques described herein may be executed by specifically programmed circuitry of processor 110. Processor 110 may thus be configured to execute the techniques described herein. Processor 110, or any other processors herein, may include one or more processors.

Memory 115 may be configured to store information during operation. Memory 115 may comprise a computer-readable storage medium. In some examples, memory 115 is a temporary memory, meaning that a primary purpose of memory 115 is not long-term storage. Memory 115, in some examples, may comprise a volatile memory, meaning that memory 115 does not maintain stored contents when the computer is turned off. Examples of volatile memories include random access memories (RAM), dynamic random access memories (DRAM), static random access memories (SRAM), and other forms of volatile memories known in the art. In some examples, memory 115 is used to store program instructions for execution by processor 110.

Database 125 may include one or more memories, repositories, databases, hard disks or other permanent storage, or any other data storage devices. Database 125 may be included in, or described as, cloud storage. In other words, information stored in database 125 and/or instructions that embody the techniques described herein may be stored in one or more locations in the cloud (e.g., one or more databases 125). Processor 110 may access the cloud and retrieve or transmit data as requested by a user. In some examples, database 125 may include Relational Database Management System (RDBMS) software. In one example, database 125 may be a relational database and accessed using a Structured Query Language (SQL) interface that is well known in the art. Database 125 may alternatively be stored on a separate networked computing device and be accessed by processor 110 through a network interface or system bus (not shown). Database 125 may in other examples be an Object Database Management System (ODBMS), Online Analytical Processing (OLAP) database or other suitable data management system. In some embodiments, the database 125 may be a relational database having structured data and unstructured data, which may be stored in the form of binary large objects (BLOB) that may be linked via fields of the database records. The unstructured data in some embodiments may simply be documents that contain notes taken by a medical professional where the database records correspond to medical records of patient encounters.

Output 130 may include one or more devices configured to accept user input and transform the user input into one or more electronic signals indicative of the received input. For example, output 130 may include one or more presence-sensitive devices (e.g., as part of a presence-sensitive screen), keypads, keyboards, pointing devices, joysticks, buttons, keys, motion detection sensors, cameras, microphones, touchscreens, or any other such devices. Output 130 may allow the user to provide input via a user interface.

Output 130 may also include one or more devices configured to output information to a user or other device. For example, output 130 may include a display screen for presenting visual information to a user that may or may not be a part of a presence-sensitive display. In other examples, output 130 may include one or more different types of devices for presenting information to a user. In some examples, output 130 may represent both a display screen (e.g., a liquid crystal display or light emitting diode display) and a printer (e.g., a printing device or module for outputting instructions to a printing device). Processor 110 may present a user interface via output 130, whereas a user may control the generation and analysis of query optimization via the user interface.

FIG. 2 is a block diagram 200 illustrating modules or programs that may be executed from memory 115 to perform methods associated with optimizing queries in various embodiments. Block 210 corresponds to the database records that include structured and unstructured data. Block 215 corresponds to a target document or documents. The target document(s) may be selected by a user desiring to perform benchmarking to compare against similar documents that may originate from different service providers or entities. In other words, in the context of medical records, a user may have a record or records corresponding to an encounter involving the treatment of one or more patients in a hospital or clinic setting. The user may have an end goal of performing benchmarking queries on similar encounters that occur or are occurring at different hospitals or clinics.

The record may include notes of a healthcare professional, also referred to as a document and unstructured data. Documents may also be included in the records of the different hospitals or clinics, or even different parts of the same facility or over a different period of time in the database. In addition to identifying the target document or documents, the user may also generate a query, represented at 220, to perform the desired benchmarking.

Block 225 represents a natural language processing (NLP) method to transform the structured and unstructured data into vectors. The target document may also be transformed into a target vector or vectors for multiple target documents. The structured and unstructured data from the database records are transformed into a weighted vector space.

Block 225 contains functionality to extract and separate an encounter record into two parts: structured patient, doctor, and facility information, and the unstructured raw text of the doctor's note. After data extraction, the NLP algorithm uses the structured and unstructured text to learn a weighted vector space. Example NLP algorithms that may be used include term frequency —inverse document frequency (TF-IDF), Latent Dirichlet Allocation (LDA), Latent Semantic Analysis (LSA), and word embeddings.

The output of the NLP algorithm is the weighted vector space. The weighted vector space allows a document, such as a medical document, to be understood by a machine. In this weighted vector space, two documents are able to be easily compared for similarities and differences. The term “weighted” is used to describe the ability of the NLP algorithm to assign additional importance to words, phrases, or structured patient information when creating the vector space. In various embodiments, different weights may be assigned, or all weights may be set to the same level, such as “1”, in order to highlight that no terms are more important than others. In further embodiments, the weighted vector space may instead be a simple list of phrases or other symbolic representations that are not vectors. Phrases or symbolic representations may be present or absent within hash tables, lists, and/or matrices.

Other representations of the document that allow it to be understood by a machine may also be used. As an example, unstructured data that is not in textual form, such as EKG measurement or images may utilize computer vision analysis, including pattern matching to generate vectors representative of the unstructured data, providing a vector space that facilitates comparison.

A TF-IDF algorithm is a natural language processing technique to learn term importance in a corpus. Here “term” may represent a word or a phrase. Each document is represented by a vector, whose entries correspond to the terms in the corpus. Therefore, the dimension of each vector is the size of the collective-corpus vocabulary. There are multiple different equations that may be used to implement the TF-IDF algorithm. Example equations used to generate entries of the vector are given by:

$${w}_{ij} = {TF}_{ij} \times {IDF}_{j}$$

$${IDF}_{j} = log \frac{1 + K}{1 + {DF}_{j}}$$

where i represents the indices of the document, j represents the indices of the term, TFᵢⱼ is the number of times term j appears in document i, DFⱼ is the number of documents term j appears in, and K is the total number of terms in the corpus. Once complete, the TF-IDF algorithm learns a weight, IDFⱼ, for every term in the vocabulary. With these weights, the documents may be tabularized, as represented Table 1, by vectors.

TABLE 1
TF-IDF Weighting Vectors

| | Term 1 | Term 2 | . . . | Term K |
|---|---|---|---|---|
| Doc 1 | w₁₁ | w₁₂ | . . . | w_{1K} |
| Doc 2 | w₂₁ | w₂₂ | . . . | w_{2K} |
| . | . | . | . | . |
| . | . | . | . | . |
| . | . | . | . | . |
| Doc N | w_{N1} | w_{N2} | . . . | w_{NK} |

Word embeddings is a feature-learning algorithm in natural language processing that maps terms to a high dimensional vector of dimension D. Again, a term may represent a word or a phrase. For every term, j, in the corpus vocabulary, a weight, wᵢⱼ, is assigned to each dimension, i, of the high dimensional space. After training is complete, a vector is learned for every term, as shown in Table 2.

TABLE 2
Word Embeddings Word Vectors

| Term 1 | Term 2 | . . . | Term K |
|---|---|---|---|
| w₁₁ | w₁₂ | . . . | w_{1K} |
| w₂₁ | w₂₂ | . . . | w_{2K} |
| . | . | . | . |
| . | . | . | . |
| . | . | . | . |
| w_{D1} | w_{D2} | . . . | w_{DK} |

Latent Dirichlet Allocation (LDA) is another algorithm that may be used to build similarity spaces. LDA is provided a number of topics present in the corpus. For each topic, LDA learns a probability distribution over terms. A document is then represented as a likelihood distribution over topics (specifying the likelihood that it is part of that topic or how much of that topic is represented in the document) based on the terms in the document.

The structured data can also serve as dimensions of the weighted vector space. For example, the structured data of interest may include age, gender, and state. Gender and state fields may not be ordinal, but numerical values may be assigned to each unique entry. With these three fields, a 3-dimensional vector may be formed. Examples may include: if there are two patients, a 35 year old man from Georgia and a 75 year old woman from Alaska, their vectorized structured data may be:

$$[ \begin{matrix}35 \\ 1 \\ 10\end{matrix} ] , [ \begin{matrix}75 \\ 2 \\ 2\end{matrix} ]$$

where male/female maps to 1 and 2, respectively and Alaska and Georgia map to 2 and 10, respectively. The formation of multi-dimensional vector may be more appropriate for ordinal values (like age) as the ordinal values can be directly compared. In other examples, the mapping assigned for gender and state may be arbitrarily based on a schema that equates a value to a gender or state.

Both the target vectors and weighted vector space may be generated as a data object or space at 230, and may be processed using a similarity algorithm indicated at 235 to produce the reduced set of records. The similarity algorithm 235 takes as input a transformed database of document vectors and transformed target document vector. It will search this database to find similar documents to the user provided target document(s). Example similarity algorithms include, but are not limited to cosine, embedding clustering algorithms, and Word Mover Distance algorithms, where similarity is represented as a distance or other numerical metric.

In some embodiments, the structured data may also be used to filter the set of records prior to searching for similar documents. For example, one may specify that they only are interested in analyzing or reviewing a dataset of a population of males between the ages of 30-45 who live in Georgia, which will be included in the query to reduce the set of documents.

Another way dimensions in the weighted vector space may be used, in the vector space, is to associate groups of words with structured fields that are systematically learned. For example, what words/phrases in the unstructured text differentiate patients who are from Alaska versus Georgia; or what words/phrases differentiate diabetics who successfully manage their insulin versus those that do not? When the vector space is built from the unstructured text, higher weights may be given to words that differentiate the subpopulations.

As described, the similarity algorithm takes as input the weighted vector space 230 and transformed target document vector. Using the weighted vector space, the similarity algorithm compares the target document vector to all documents in the database to determine a similarity score for each document. Note that in some embodiments, the number of documents to compare may be reduced by filtering the structured data in the corresponding records, based on the query.

Stated more generally, the similarity algorithm takes the target record provided by the user and the database of structured and unstructured data and transforms them into the weighted vector space learned during the training stage. In this transformed space, the algorithm compares the target record to all the records in the database to identify similar patients/encounters. Note that in some embodiments, the number of records to compare with the target record may be reduced by filtering based on structured data within the target record.

In one embodiment, cosine similarity may be used to implement the similarity algorithm. In cosine similarity, the similarity between documents represented by unit normed vectors wᵢ and wⱼ is

sim(i,f)= [symbol] wᵢ,wⱼ

[symbol]

Here, <x,y>, represents the mathematical operation of an inner product between two vectors x and y. This algorithm is appropriate for both TF-IDF and LDA.

In a further embodiment, word-embedding clustering may be used to implement the similarity algorithm. Using word embedding clustering, words are first clustered into similar groups Each document is then represented as a vector where each dimension corresponds to the number of words in the document that fall into the associated group. The cosine similarity metric may then be applied to these document vectors.

In a word-embedding weighted/unweighted document average, a document is represented as a weighted/unweighted average of all word embedding vectors for all words in a document. In one embodiment, the vector entries are not guaranteed to be non-negative, so the similarity metric could be:

½(1+wᵢ,wⱼ

[symbol]

[symbol]

where <x,y> is the inner product between two unit normed vectors x and y.

The user (most likely a hospital administrator or provider) through an interface or display (i.e., Output 130 in FIG. 1) provides the target patient and/or healthcare encounter record. This record may already be in the database, but may also be a newly created record.

The similarity algorithm 235 returns a ranked list of records that are most similar to the target record provided by the user. A user can then select a similarity threshold to include records within the similarity threshold in a reduced set of records. Other ways to control the number of records in the reduced set may include filtering and returning the top X number of documents or the top Y % of available documents. As an example, the algorithm may be instructed to identify and display ten documents or 10% of the total documents that may be relevantly reduced. Each record so included may be thought of as a virtual cohort. These records are deemed to be the most similar to the target record. The performance on the target document may be compared to the performance of the aggregate of the virtual cohorts via queries 220 to benchmark performance on similar encounters as indicated at 240 where the query 220 is executed over the reduced set of records to provide query results at 250. The queries in one embodiment may be performed over the weighted vector space in the reduced set of records, and may include generation of statistics corresponding to the results which may be used to determine average lengths of stay, cost, and other measure of performance of similar medical facilities treating similar patients in some healthcare related embodiments.

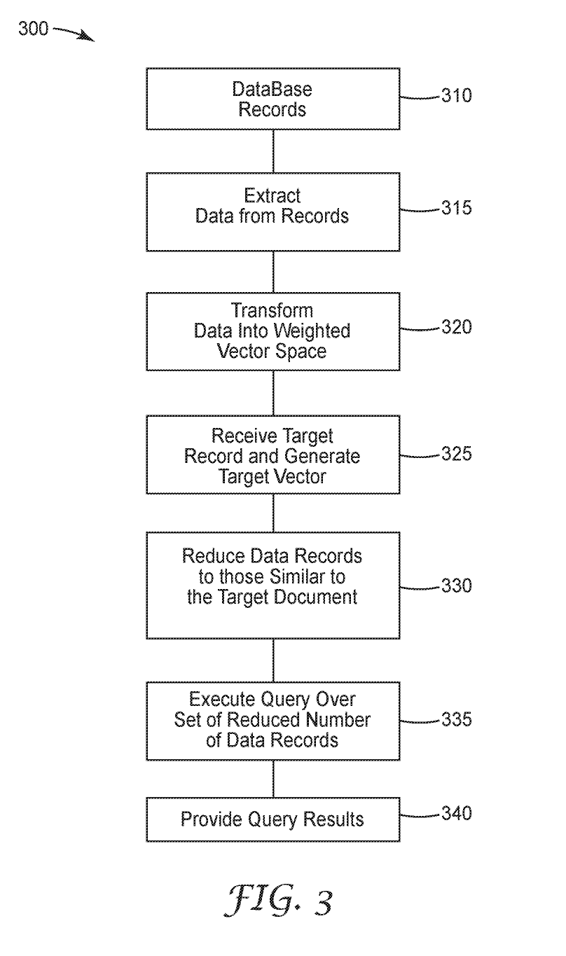

FIG. 3 is a flowchart illustrating a method 300 of optimizing a structured data query utilizing natural language processing of unstructured data to reduce a set of records for execution of the query. Method 300 may utilize one or more of the modules or programs executing on a computer or computers as described in FIG. 2. Note that the modules or programs may be separate or combined in various embodiments and implemented in a high level computer programming language, an application specific integrated circuit, cloud based computing resources, or combination thereof.

A set of data records is obtained from the database at 310. The data records contain structured data and unstructured data documents. The structured data may contain fields that have specific values or ranges of values.

At 315, the structured and unstructured data is extracted from the set of data records and provided for transformation at 320. The transformation may utilize natural language processing techniques to transform the unstructured data, corresponding to documents, into a weighted vector space. Executing a natural language processing algorithm on a processor transforms the unstructured data into a vector that is an element of a weighted vector space. In one embodiment, the natural language processing algorithm comprises a term frequency-inverse document frequency (TF-IDF) algorithm, a word embedding algorithm, LDA, or a combination in various embodiments. In further embodiments the similarity algorithm comprises a cosine similarity algorithm or a word embedding clustering algorithm.

At 325, a target data record containing structured and unstructured data is received, and a target vector for the target data record is generated. The target vector may be an element of the weighted vector space. At 330, a similarity algorithm is executed using the target vector space of the target data record and the weighted vector space corresponding to the set of data records to provide a reduced number of data records that are most similar to the target document.

At 335, a query or queries are executed against the reduced number of data records that are most similar to the target data record. The query or queries may be related to performing benchmarking in one embodiment. In one embodiment, executing a query against the reduced number of data records that are most similar to the target data record further comprises providing a list of results of the query against the reduced number of data records that are most similar to the target data record. The list of results may be ranked and displayed.

In one embodiment, the unstructured data documents comprise text descriptive of an event wherein the NLP algorithm to provide the weighted vector space is selected as a function of a type of the event.

Executing the natural language processing algorithm may include filtering records based on the structured data such that the weighted vector space is a function of the structured data.

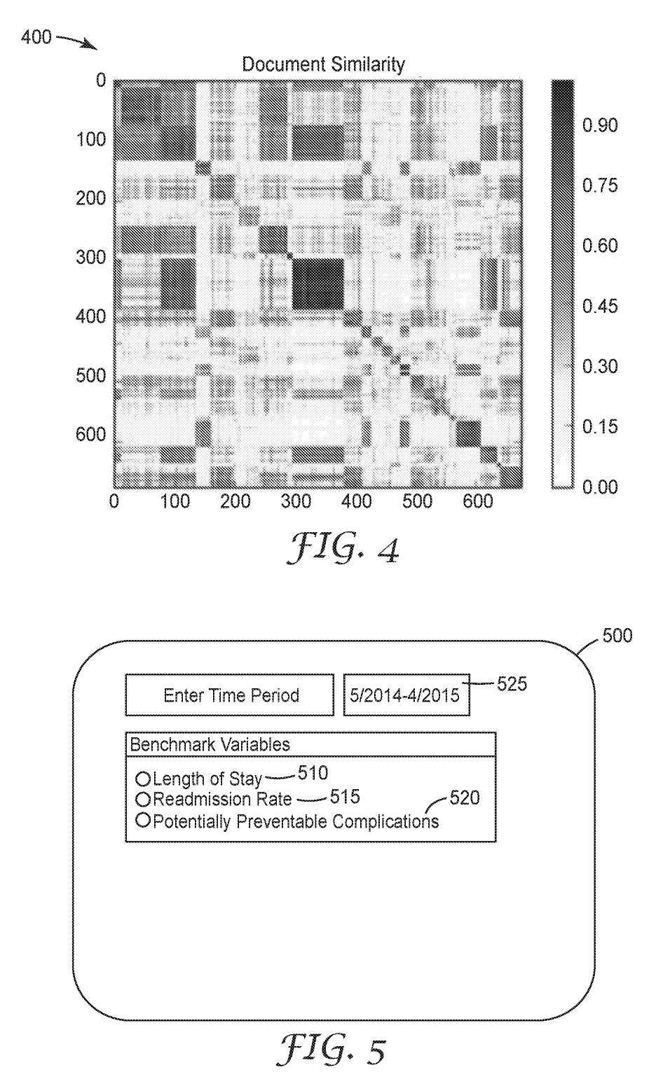

FIG. 4 is a representation of a sample similarity matrix 400, which may be an output illustrating the similarity between all documents in a database. Each column in this matrix represents a document. The corresponding row is the same document (i.e. a row i, wherein i is between 0 and 700 and a column i represent the same document). There are about 700 documents in this database. Each entry in the matrix represents the similarity score between document i and document j. Note that a similarity score in one embodiment is inversely proportional to a distance between two documents. A similarity score of 0 represents no similarity and is color-coded white. A score of 1 represents perfect similarity, corresponding to no distance between the documents, and is color-coded black. The shade of an entry is thus graded between black and white. The matrix is symmetric as the similarity between document i and document j is the same as the similarity between document j and document i. Note that the granularity of the entries is too small to see representations of individual documents, otherwise a black diagonal line would be visible, corresponding the same document being compared to itself at each point along the line. As the figure shows, there are natural groups of documents that are all similar to each other. Documents with a high similarity value would be put into the same group and would be treated as peer records by the virtual cohort.

FIG. 5 is an example screen shot of a query entry screen 500 for generation of a query by a user. The screen shot illustrates benchmark variables, including length of stay 510, readmission rate 515, and potentially preventable complications 520. A field for entering a time period is also provided at 525. In further embodiments, different fields may be provided depending on the parameter being benchmarked. In still further embodiments, a user may generate queries of their own using a structured query language such as SQL or natural language queries.

Screen 500 also illustrates an interface for generating filters for use on the set of records to reduce the number of records prior to searching for similar documents. For instance, the time period 525 may be used to filter the records such that only records having documents in the time period are used to generate the rejected set of records. Other structured data, such as gender, age, state, or other data or combinations of data may also be used to filter the records prior to generating the reduced set of records considered for identifying similar documents.

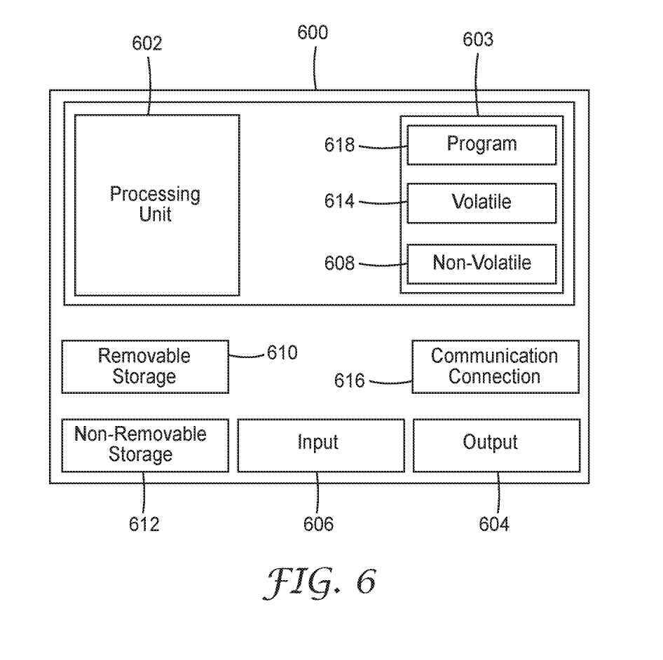

FIG. 6 is a block schematic diagram of a computer system 600 to implement methods according to example embodiments. All components need not be used in various embodiments. One example computing-device, in the form of a computer 600, may include a processing unit 602, memory 603, removable storage 610, and non-removable storage 612. Although the example computing-device is illustrated and described as computer 600, the computing device may be in different forms in different embodiments. For example, the computing-device may instead be a smartphone, a tablet, smartwatch, or other computing device including the same or similar elements as illustrated and described with regard to FIG. 6. Devices such as smartphones, tablets, and smartwatches are generally collectively referred to as mobile devices. Further, although the various data storage elements are illustrated as part of the computer 600, the storage may also or alternatively include cloud-based storage accessible via a network, such as the Internet.

Memory 603 may include volatile memory 614 and non-volatile memory 608. Computer 600 may include—or have access to a computing environment that includes—a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

Computer 600 may include or have access to a computing environment that includes input 606, output 604, and a communication connection 616. Output 604 may include a display device, such as a touchscreen, that also may serve as an input device. The input 606 may include one or more of a touchscreen, touchpad, mouse, keyboard, camera, one or more device-specific buttons, one or more sensors integrated within or coupled via wired or wireless data connections to the computer 600, and other input devices. The computer may operate in a networked environment using a communication connection to connect to one or more remote computers, such as database servers, including cloud based servers and storage. The remote computer may include a personal computer (PC), server, router, network PC, a peer device or other common network node, or the like. The communication connection may include a Local Area Network (LAN), a Wide Area Network (WAN), cellular, WiFi, Bluetooth, or other networks.

Computer-readable instructions stored on a computer-readable storage device are executable by the processing unit 602 of the computer 600. A hard drive, CD-ROM, and RAM are some examples of articles including a non-transitory computer-readable medium such as a storage device. The terms computer-readable medium and storage device do not include carrier waves. For example, a computer program 618 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 600 to provide generic access controls in a COM based computer network system having multiple users and servers.

### EXAMPLES

1. In example 1, a method of optimizing a query over a database includes:
obtaining a set of data records from the database, the data records containing structured data and unstructured data documents;
extracting the structured and unstructured data from the set of data records;
transforming the structured and unstructured data into a vector that is an element of a weighted vector space;
receiving a target data record containing structured and unstructured data;
generating a target vector for the target data record;
executing a similarity algorithm using the target vector and the weighted vector space generated by the collection of database records to provide a reduced number of data records that are most similar to the target data record; and
executing a query against the reduced number of data records that are most similar to the target data record.

2. The method of example 1 wherein the structured data comprises fields having specific values or ranges.

3. The method of any of examples 1-2 wherein the unstructured data comprises text, and wherein transforming is performed by executing a natural language processing algorithm comprising a term frequency-inverse document frequency (TF-IDF) algorithm, Latent Dirichlet Allocation (LDA), Latent Semantic Analysis (LSA), word embeddings, or combinations thereof.

4. The method of any of examples 1-3 wherein the similarity algorithm comprises a cosine similarity algorithm.

5. The method of any of examples 1-4 wherein the similarity algorithm comprises a word embedding clustering algorithm.

6. The method of any of examples 1-5 wherein the similarity algorithm comprises a word mover distance algorithm.

7. The method of any of examples 1-6 wherein executing a query against the reduced number of data records that are most similar to the target data record further comprises providing a list of results of the query against the reduced number of data records that are most similar to the target data record.

8. The method of example 7, wherein the list of results is ranked and displayed.

9. The method of any of examples 7-8 and further comprising computing statistics based on a value of at least one selected field of the structured data in the list of results.

10. The method of any of examples 1-9 wherein the unstructured data documents comprise text descriptive of an event wherein transforming is performed by executing a natural language processing algorithm to provide the weighted vector space is selected as a function of a type of the event.

11. The method of any of examples 1-10 wherein transforming further comprises filtering records based on the structured data such that the weighted vector space is a function of the structured data.

12. A machine readable storage device having instructions for execution by a processor of the machine to perform operations comprising:
obtaining a set of data records from the database, the data records containing structured data and unstructured data documents;
extracting the structured and unstructured data from the set of data records;
transforming the structured and unstructured data into a vector that is an element of a weighted vector space;
receiving a target data record containing structured and unstructured data;
generating a target vector for the target data record, the target vector being an element of the weighted vector space;
executing a similarity algorithm using the target vector space of the target data record and the weighted vector space corresponding to the set of data records to provide a reduced number of data records that are most similar to the target data record; and
executing a query against the reduced number of data records that are most similar to the target data record.

13. The machine readable storage device of example 12 wherein the unstructured data comprises text, and wherein transforming is performed by executing a natural language processing algorithm comprising a term frequency-inverse document frequency (TF-IDF) algorithm, a word embeddings algorithm, or a combined word embeddings and TF-IDF algorithm.

14. The machine-readable storage device of any of examples 12-13 wherein the similarity algorithm comprises a cosine similarity algorithm, a word embedding clustering algorithm or word mover distance algorithm.

15. The machine readable storage device of any of examples 12-14 wherein executing a query against the reduced number of data records that are most similar to the target data record further comprises providing a list of results of the query against the reduced number of data records that are most similar to the target data record.

16. The machine readable storage device of any of examples 12-15 wherein the unstructured data documents comprise comprising text descriptive of an event wherein the NLP algorithm to provide the weighted vector space is selected as a function of a type of the event.

17. The machine readable storage device of any of examples 12-16 wherein transforming further comprises filtering records based on the structured data such that the weighted vector space is a function of the structured data.

18. A device comprising:
a processor; and
a memory device coupled to the processor and having a program stored thereon for execution by the processor to perform operations comprising:
   obtaining a set of data records from the database, the data records containing structured data and unstructured data documents;
   extracting the structured and unstructured data from the set of data records;
   transforming the structured and unstructured data into a vector that is an element of a weighted vector space;
   receiving a target data record containing structured and unstructured data;
   generating a target vector for the target data record, the target vector being an element of the weighted vector space;
   executing a similarity algorithm using the target vector space of the target data record and the weighted vector space corresponding to the set of data records to provide a reduced number of data records that are most similar to the target data record; and
   executing a query against the reduced number of data records that are most similar to the target data record.

19. The device of example 18 wherein the unstructured data comprises text, and wherein transforming is performed by executing a natural language processing algorithm comprising a term frequency-inverse document frequency (TF-IDF) algorithm, a word embeddings algorithm, or a combined word embeddings and TF-IDF algorithm.

20. The device of any of examples 18-19 wherein the similarity algorithm comprises a cosine similarity algorithm, a word embedding clustering algorithm, or a word mover distance algorithm.

21. The device of any of examples 18-20 wherein executing a query against the reduced number of data records that are most similar to the target data record further comprises providing a list of results of the query against the reduced number of data records that are most similar to the target data record and computing statistics based on a value of at least one selected field of the structured data in the list of results.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method of optimizing a query over a database, the method comprising:
obtaining a set of data records from the database, the data records containing structured data and unstructured data documents;
extracting the structured and unstructured data from the set of data records;
transforming the structured and unstructured data into a vector that is an element of a weighted vector space;
receiving a target data record containing structured and unstructured data;
generating a target vector for the target data record;
executing a similarity algorithm using the target vector and the weighted vector space generated by the collection of database records to provide a reduced number of data records that are most similar to the target data record; and
executing a query against the reduced number of data records that are most similar to the target data record.

2. The method of claim 1 wherein the unstructured data comprises text, and wherein transforming is performed by executing a natural language processing algorithm comprising a term frequency-inverse document frequency (TF-IDF) algorithm, Latent Dirichlet Allocation (LDA), Latent Semantic Analysis (LSA), word embeddings, or combinations thereof.

3. The method of claim 1 wherein the similarity algorithm comprises at least one of a cosine similarity algorithm, a word embedding clustering algorithm, and a word mover distance algorithm.

4. The method of claim 1 wherein executing a query against the reduced number of data records that are most similar to the target data record further comprises providing a list of results of the query against the reduced number of data records that are most similar to the target data record.

5. The method of claim 4, wherein the list of results is ranked and displayed.

6. The method of claim 4, further comprising computing statistics based on a value of at least one selected field of the structured data in the list of results.

7. The method of claim 1 wherein the unstructured data documents comprise text descriptive of an event wherein transforming is performed by executing a natural language processing algorithm to provide the weighted vector space is selected as a function of a type of the event.

8. The method of claim 1 wherein transforming further comprises filtering records based on the structured data such that the weighted vector space is a function of the structured data.

9. A machine readable storage device having instructions for execution by a processor of the machine to perform operations comprising:
obtaining a set of data records from the database, the data records containing structured data and unstructured data documents;
extracting the structured and unstructured data from the set of data records;
transforming the structured and unstructured data into a vector that is an element of a weighted vector space;
receiving a target data record containing structured and unstructured data;
generating a target vector for the target data record, the target vector being an element of the weighted vector space;
executing a similarity algorithm using the target vector space of the target data record and the weighted vector space corresponding to the set of data records to provide a reduced number of data records that are most similar to the target data record; and
executing a query against the reduced number of data records that are most similar to the target data record.

10. The machine readable storage device of claim 9 wherein the unstructured data comprises text, and wherein transforming is performed by executing a natural language processing algorithm comprising a term frequency-inverse document frequency (TF-IDF) algorithm, a word embeddings algorithm, or a combined word embeddings and TF-IDF algorithm.

11. The machine-readable storage device of claim 9 wherein the similarity algorithm comprises a cosine similarity algorithm, a word embedding clustering algorithm or word mover distance algorithm.

12. The machine readable storage device of claim 9 wherein executing a query against the reduced number of data records that are most similar to the target data record further comprises providing a list of results of the query against the reduced number of data records that are most similar to the target data record.

13. The machine readable storage device of claim 9 wherein the unstructured data documents comprise comprising text descriptive of an event wherein transforming is performed by executing a natural language processing algorithm to provide the weighted vector space, the natural language processing algorithm being selected as a function of a type of the event.

14. The machine readable storage device of claim 9 wherein transforming further comprises filtering records based on the structured data such that the weighted vector space is a function of the structured data.

15. A device comprising:
a processor; and
a memory device coupled to the processor and having a program stored thereon for execution by the processor to perform operations comprising:
obtaining a set of data records from the database, the data records containing structured data and unstructured data documents;
extracting the structured and unstructured data from the set of data records;
transforming the structured and unstructured data into a vector that is an element of a weighted vector space;
receiving a target data record containing structured and unstructured data;
generating a target vector for the target data record, the target vector being an element of the weighted vector space;
executing a similarity algorithm using the target vector space of the target data record and the weighted vector space corresponding to the set of data records to provide a reduced number of data records that are most similar to the target data record; and
executing a query against the reduced number of data records that are most similar to the target data record.

16. The device of claim 15 wherein the unstructured data comprises text, and wherein transforming is performed by executing a natural language processing algorithm comprising a term frequency-inverse document frequency (TF-IDF) algorithm, a word embeddings algorithm, or a combined word embeddings and TF-IDF algorithm.

17. The device of claim 15 wherein the similarity algorithm comprises a cosine similarity algorithm, a word embedding clustering algorithm, or a word mover distance algorithm.

18. The device of claim 15 wherein executing a query against the reduced number of data records that are most similar to the target data record further comprises providing a list of results of the query against the reduced number of data records that are most similar to the target data record and computing statistics based on a value of at least one selected field of the structured data in the list of result
